(19) United States
(12) Patent Application Publication
(10) Pub. No.: US 2009/0058073 A1
(43) Pub. Date: Mar. 5, 2009

(54) Pressure-Sensitive Folded Label with No Base Carrier

(75) Inventor: John W. George, St. Joseph, MO (US)

Correspondence Address: HOVEY WILLIAMS LLP, 10801 Mastin Blvd., Suite 1000, Overland Park, KS, 66210, US

(73) Assignee: EXPRESS CARD AND LABEL CO., INC., Topeka, KS (US)

(21) Appl. No.: 11/848,471

(22) Filed: Aug. 31, 2007

(51) Int. Cl. B42D 15/10; B42D 15/04

(52) U.S. Cl. 283/81; 283/106

(57) ABSTRACT

A web label product comprises a series of folded labels releasably attached to an elongated liner so that the labels may be peeled off at high speeds and applied to a line of fast-moving web material, individual publications such as newspaper sections or magazines, or other articles. The folded labels are directly adhered to the liner without the use of an intermediate base carrier label and are correspondingly adapted for direct application to the articles without an intermediate base carrier label. A number of different embodiments are presented disclosing variations in the way of folding the labels and releasably maintaining them in such folded condition.

### TECHNICAL FIELD

The present invention relates to labels that are supplied in bulk on web-like liners and, more particularly, to so-called multi-panel “extended note” labels that can be mechanically peeled from their liners at high speeds and applied to rapidly moving newspaper sections, magazines, publications, webs of material or other articles to serve as folded advertisements, coupons, instructions, notes and other types of informational items.

### BACKGROUND AND SUMMARY

Currently known extended note labels typically comprise a multi-panel folded document or “note” that is retained in a “pocket” on the adhesive-free front face of a pressure-sensitive carrier label. The outer layer of the pocket is formed by a transparent overlaminate layer that is permanently adhered to both the folded document in the pocket and the front face of the carrier label. This resulting label assembly can be adhered as an advertisement or coupon to a newspaper section or other article using the adhesive-coated back side of the carrier label. When the ultimate customer desires to remove the folded note for inspection or use, he typically must tear a covering portion of the overlaminate and the entire note free from the carrier label and leave the carrier label and remnants of the overlaminate behind on the article. If the carrier label and its adhesive are transparent, text or images on the newspaper or other article beneath the carrier label can still viewed. However, even in that instance the left-over carrier label is still a nuisance and the newspaper cannot be properly recycled due to the presence of the plastic label residue on the newspaper. Moreover, the carrier label and overlaminate add significant cost to the folded note.

The present invention is directed to an extended note product that can be reliably attached through high-speed mechanical means directly to a wide variety of articles including, for example, individual items of mass publication such as newspapers and magazines, or to continuous webs of such items, without an intervening carrier label, thus avoiding the problems and shortcomings associated with conventional extended note products. In accordance with a preferred embodiment of the present invention, the extended note is in the nature of a folded label having repositionable adhesive on its back side that permits the label to be quickly and cleanly removed from the publication or other article by the ultimate customer and temporarily adhered to some environmental surface, such as the front face of a refrigerator, desk or wall, all without leaving behind any residue on the article. The label is maintained in its folded condition by a number of alternate methods throughout storage, high-speed application to an article, and subsequent handling until intentionally unfolded by the ultimate user. In preferred embodiments, bulk volumes of the labels are carried on web-like liners that can be presented to high-speed label applying machines for peeling the labels from the liners and attaching them to a continuous web of material or a line of rapidly moving individual articles such as newspaper sections, magazines or other items of publication. In other forms of the invention, the adhesive used on the back side of the label may be a permanent adhesive so that once the label is peeled from the liner and applied to the article, it remains permanently attached to the article.

### BRIEF DESCRIPTION OF THE DRAWINGS

FIG. 1 is an isometric view of a newspaper section to which a folded label in accordance with the present invention has been applied in order to illustrate one exemplary use of the label;

FIG. 2 is a fragmentary isometric view of one embodiment of a folded web label product in accordance with the present invention, illustrating how labels may be supplied in bulk on a suitable liner;

FIG. 3 is an enlarged isometric view of the unfolded label of FIG. 2 revealing the top side of the label;

FIG. 4 is an isometric view of the label of FIG. 2 in a partially folded condition showing some of the adhesive on the back side of the label;

FIG. 5 is an isometric view of the back side of the label of FIG. 2;

FIG. 6 is an isometric view of a second embodiment of a folded web label product in accordance with the present invention;

FIG. 7 is an isometric view of the folded label of FIG. 6 in a partially unfolded condition to illustrate adhesive used in maintaining the label folded;

FIG. 8 is an isometric view of the label of FIG. 6 in a further unfolded condition illustrating additional details of construction;

FIG. 9 is an isometric view of the top side of the label of FIG. 6 in a fully unfolded condition;

FIG. 10 is an isometric view of the back side of the label of FIG. 6 in a fully unfolded condition;

FIG. 11 is an isometric view of a third embodiment of a folded web label product in accordance with the present invention, the label being shown partially unfolded;

FIG. 12 is an isometric view of the top side of the label of FIG. 11 in a fully unfolded condition;

FIG. 13 is an isometric view of the back side of the label of FIG. 11 in a fully unfolded condition;

FIG. 14 is an isometric view of a fourth embodiment of a folded web label product in accordance with the present invention, one of the labels being illustrated partially unfolded and layers being shown in an exploded condition to reveal details;

FIG. 15 is an isometric view of the label of FIG. 14 in a partially unfolded condition;

FIG. 16 is an isometric view of the top side of the label of FIG. 14 in a fully unfolded condition;

FIG. 17 is an isometric view of the back side of the label of FIG. 14 in a fully unfolded condition;

FIG. 18 is an isometric view of a fifth embodiment of a folded web label product in accordance with the present invention;

FIG. 19 is an isometric view of the label of FIG. 18 in a partially unfolded condition;

FIG. 20 is an isometric view of the top side of the label of FIG. 18 in a fully unfolded condition;

FIG. 21 is an isometric view of the back side of the label of FIG. 18 in a fully unfolded condition;

FIG. 22 is an isometric view of a sixth embodiment of a folded web label product in accordance with the present invention;

FIG. 23 is an isometric view of the label of FIG. 22 in a partially unfolded condition;

FIG. 24 is an isometric view of the label of FIG. 22 in a partially unfolded condition and with layers in an exploded format to reveal details of construction;

FIG. 25 is an isometric view of the back side of the label of FIG. 22 in a fully unfolded condition; and

FIG. 26 is an isometric view of the front side of the label of FIG. 22 in a fully unfolded condition.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

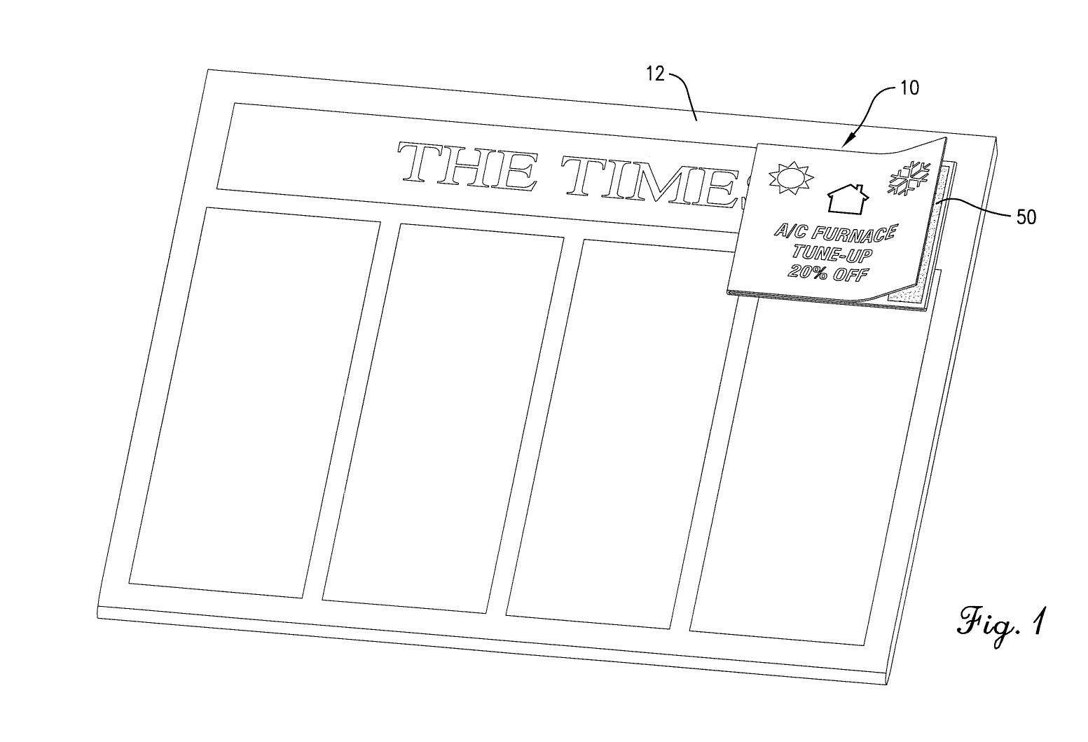

Folded labels in accordance with the present invention are preferably produced in large quantities as part of a web label product comprising the labels themselves and an essentially continuous web-type liner to which the labels are temporarily adhered. The labels are designed to be peeled from the liner by conventional label applying machines and applied at high speeds to a variety of articles such as, for example, newspaper sections and other publications (or to fast-moving webs of material that may be used to produce the publications). Thus, FIG. 1 illustrates a folded label 10 comprising part of a web label product in accordance with the present invention wherein label 10 has been removed from its liner and applied to the front of a newspaper section 12 in a suitable location. As will be seen, label 10 and the other labels hereinafter described are preferably provided with a suitable repositionable adhesive that enables the label to not only be applied to the newspaper or other article during production, but also later easily peeled therefrom by the ultimate user and reapplied to a convenient environmental surface such as the front of a refrigerator door or the like. It is also within the scope of the present invention, however, to use a permanent, rather than repositionable, adhesive to attach the labels to articles, in which case the labels are permanently adhered to the articles.

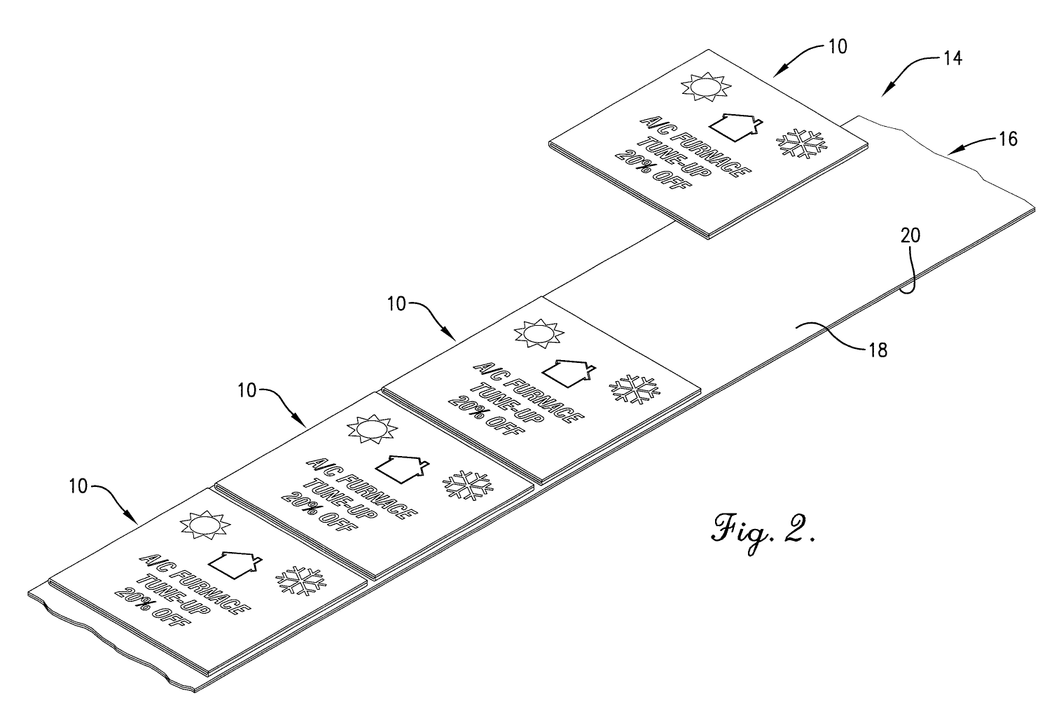

FIG. 2 illustrates one embodiment of a folded web label product 14 in accordance with the present invention and comprising two major components, i.e., the label 10 illustrated in FIG. 1 and a long web-type liner 16. A number of labels 10 are attached to and carried by liner 16 at spaced intervals along the length thereof. Preferably, liner 16 is flat-folded in an accordion-like manner to present a stack of reversely folded flat plies instead of a continuous roll, although both of such arrangements are within the purview of the present invention. In a most preferred embodiment, liner 16 may take the form of an essentially perforation-free liner in which successive folds of the flat-folded liner are formed by alternately oppositely facing creases or pre-folds in the liner in accordance with the principles in co-pending application Ser. No. 11/172,540 filed Jun. 30, 2005, and titled “Fan-Folded Web of Pressure-Sensitive Labels and Method and Apparatus for Making and Using Same.” The '540 application and its corresponding Patent Application Publication No. US 2007/0004575 are hereby incorporated by reference into the present specification.

Liner 16 maybe constructed from any suitable paper stock or the like and is supplied on at least one side thereof with a suitable release coating 18 to which the labels 10 are removably adhered. The layer of paper stock is denoted by the numeral 20. Preferably, liner 16 is only slightly wider than label 10 when the label 10 is in a fully folded condition as illustrated in FIG. 2.

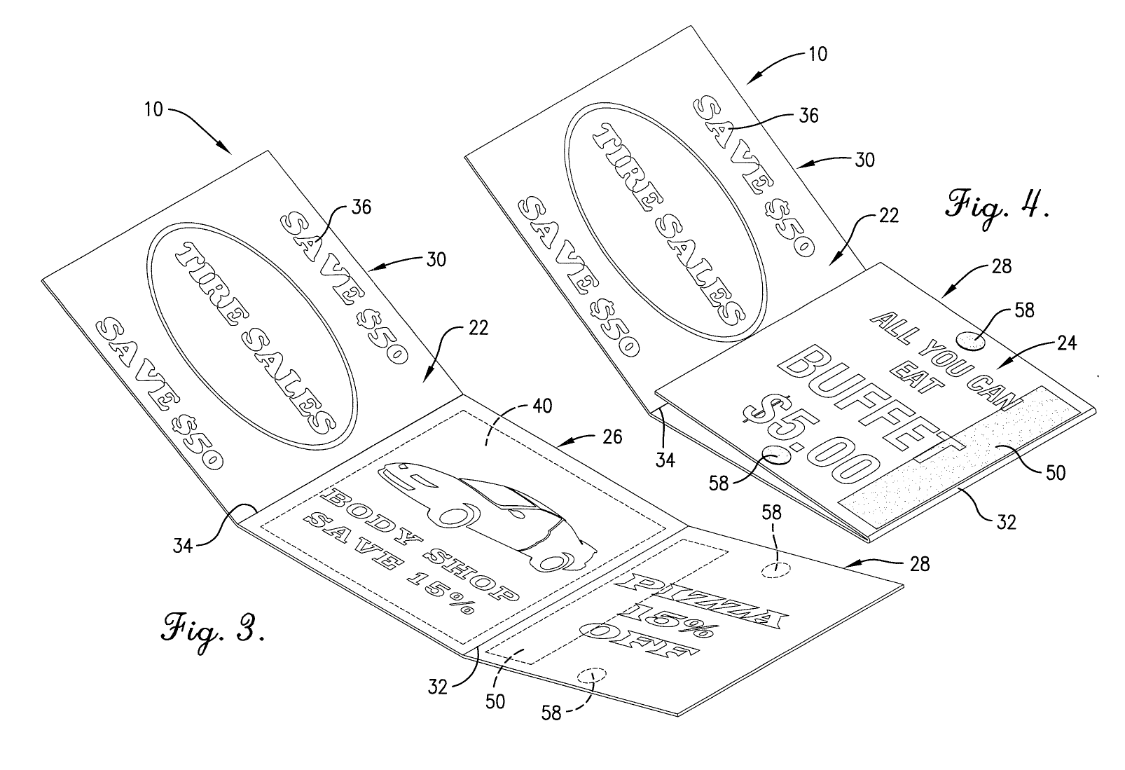

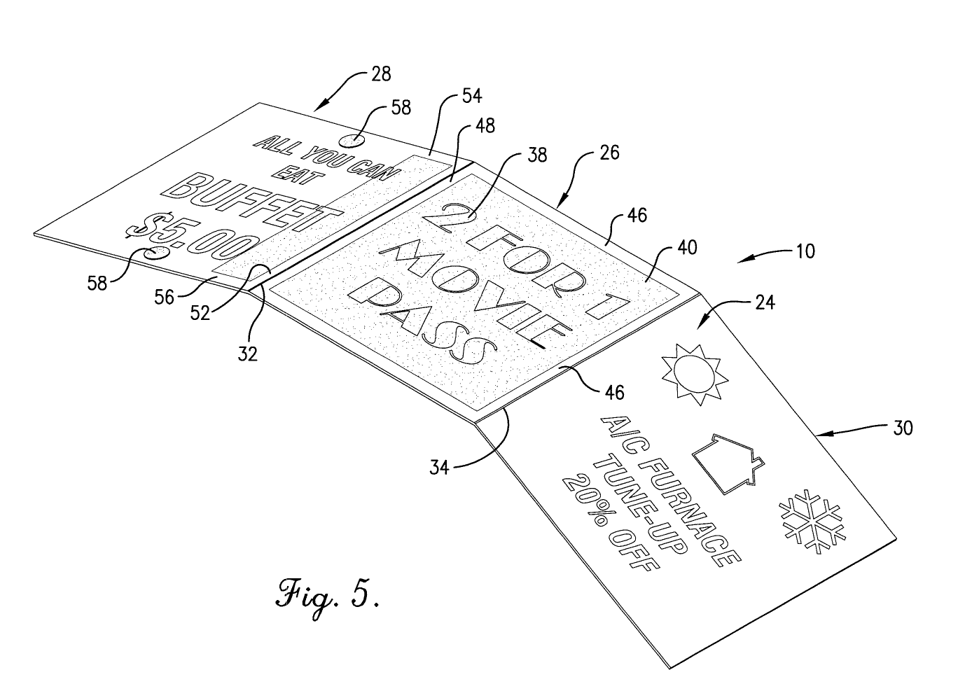

As illustrated also in FIGS. 3, 4 and 5, folded label 10 is rectangular in configuration and has a front side 22 and an opposite back side 24. This particular embodiment is a six-panel label, comprising at least three flat sections including a first central section 26, a second wing section 28, and a third wing section 30 on the opposite side of central section 26. Wing sections 28 and 30 are integrally connected to central section 26 by a pair of laterally spaced fold lines 32 and 34 that extend longitudinally of liner 16 when label 10 is adhered thereto as in FIG. 2. Label 10 is constructed from any suitable stock, such as paper, and may advantageously have various indicia applied to front side 22 and back side 24 as exemplified by the indicia 36 and 38. Such indicia may take the form of various text information or images, depending upon the final intended use for the label. In the illustrated embodiment, label 10 may be utilized as a source of advertisement or as redeemable coupon(s) usable at various places of business.

Back side 24 of central section 26 is provided with a region of transparent repositionable or adhesive 40 such as a suitable micro-sphere adhesive of the type that is well known to those skilled in the art and readily available commercially from a number of sources. Alternatively, adhesive 40 may comprise a suitable permanent adhesive, such as a hot melt adhesive, which is also well known and readily commercially available by those skilled in the art. Preferably, adhesive region 40 is of rectangular configuration and is of slightly reduced dimensions relative to central section 26 so as to present four clear margins 42, 44, 46 and 48 in which no adhesive is located. Clear margins 46 and 48 thus lie alongside of fold lines 32 and 34 to provide separation between adhesive region 40 and such fold lines. Adhesive region 40 comprises the means which label 10 is releasably adhered to liner 16 in contacting engagement with release coating 18.

As illustrated particularly in FIGS. 2 and 4, when label 10 is in its fully folded condition, the second wing section 28 is folded in about fold line 32 into overlying relationship with central section 26. In turn, third wing section 30 is folded in about fold line 34 into overlying relationship with second section 28. Consequently, sections 26, 28 and 30 are all disposed in mutually superimposed relationship when label is fully folded as in FIG. 2. It will be noted that in this condition, and while label 10 is adhered to liner 16, the back side of third section 30 faces upwardly and becomes the top of the folded label.

In order to hold label 10 in a fully folded condition throughout its adherence to liner 16 and subsequent attachment to an article such as newspaper section 12, the back side 24 of label 10 in the area of second section 28 is provided with an area of transparent, repositionable adhesive which is disposed to be contacted by the front side of third section 30 when the latter overlies second section 28. To this end, the back side of second section 28 is preferably provided with a strip 50 of transparent repositionable adhesive generally adjacent fold line 32. In a preferred embodiment, strip 50 is spaced away from fold line 32 so as to present a clear margin 52 alongside fold line 32 in which no adhesive exists. Similarly, preferably strip 50 terminates at its opposite ends short of the corresponding edges of wing section 28 so as to present clear margins 54 and 56 at opposite ends of strip 50 where no adhesives exists. Thus, when label 10 is folded, adhesive strip 50 is well-positioned to be contacted by the outer edge portion of the front side of wing section 30.

For additional help in holding wing section releasably closed against wing section 28, the area of repositionable adhesive on the back side of wing section 28 may include one or more spots 58 that are spaced from strip 50 generally toward the opposite edge of wing section 28. Spots 58 may take a variety of different shapes and are preferably only a very light or thin presence of adhesive.

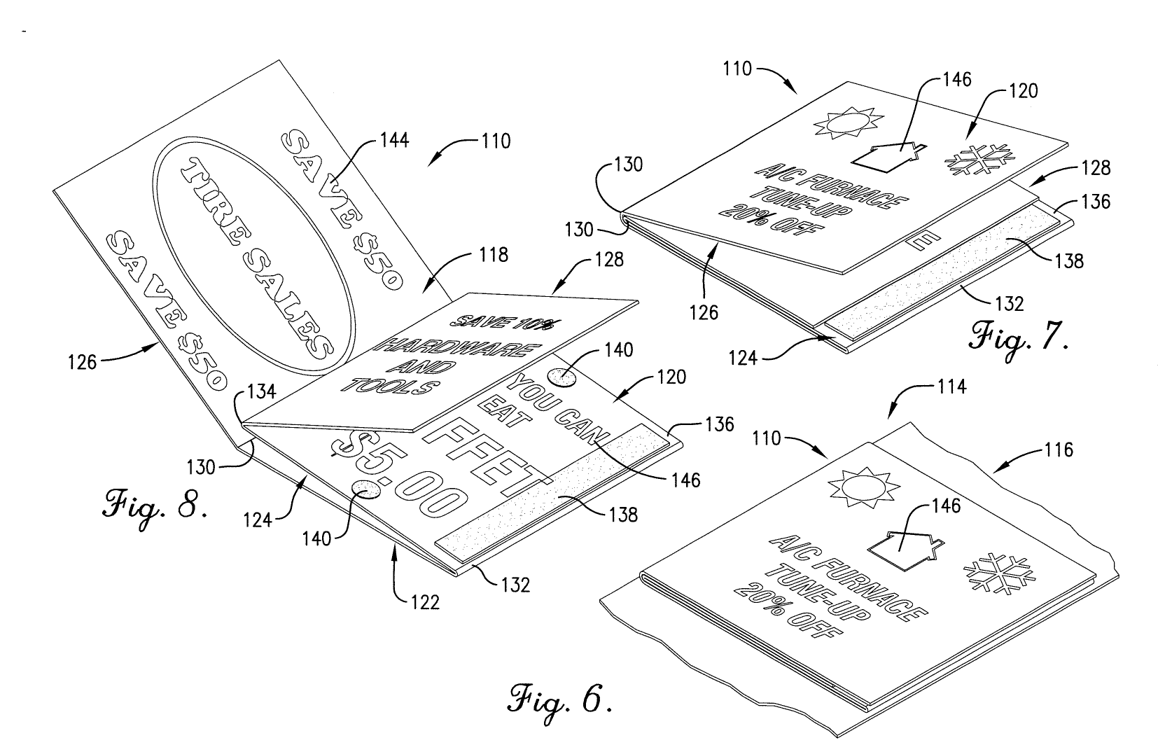

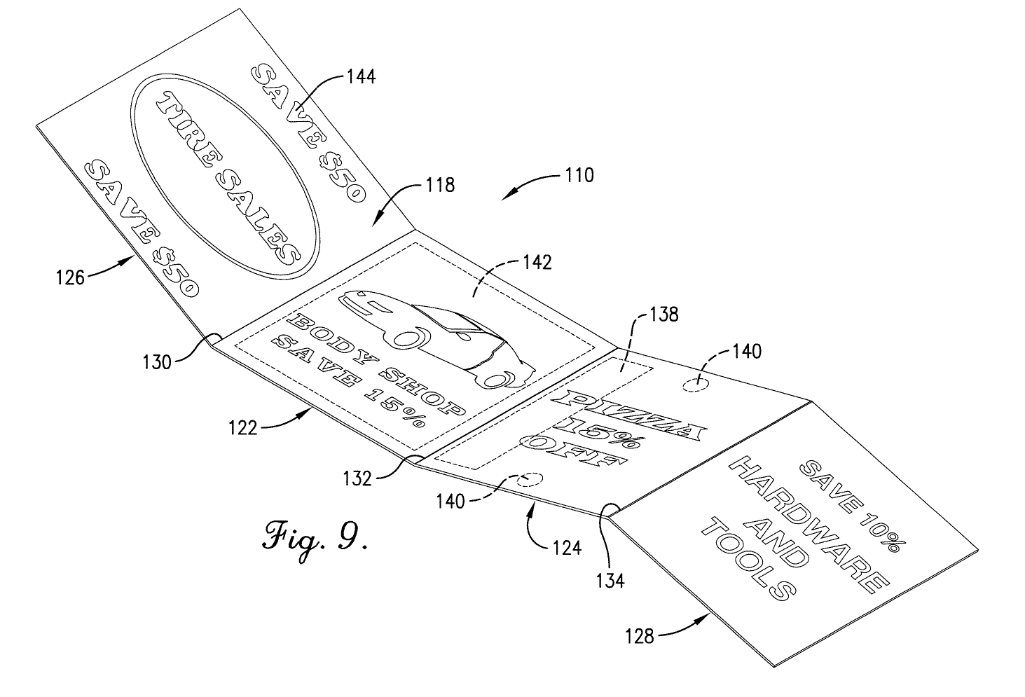

FIGS. 6-10 disclose a second embodiment of a folded web label product 114 including a folded label 110 and a liner 116. In the embodiment of FIGS. 6-10, and in all embodiments hereinafter described, the liner 116 is the same construction as liner of the first embodiment. The differences in the various embodiments of folded web label products reside in the folded labels of each embodiment. Additionally, it is to be understood that the materials form which each of the folded labels is constructed are the same in each instance, as are the adhesives utilized (unless otherwise specified to the contrary). The differences thus reside primarily in the number of folded sections associated with each embodiment, the way they are folded, the sizes of the sections in some instances, and the technique for maintaining the labels in a folded condition while they remain adhered to the liner and during the time that they are secured to an article such as a newspaper section.

Thus, label 110 of FIGS. 6-10 illustrates one way of having an eight panel folded label wherein the label has four flat sections and two opposite sides (front and back) to provide the eight panels or surfaces upon which indicia can be printed. As should be apparent, the concepts of the present invention are not limited to any particular number of panels or sections; thus, although the embodiment of FIGS. 6-10 contemplates a total of four sections, it could also have any number of additional sections without departing from the principles of the present invention.

In the illustrated embodiment of FIGS. 6-10, label 110 has a front side 118 and a back side 120. It is folded into four sections, namely a first section 122, a second section 124, a third section 126, and a fourth section 128. Three fold lines 130, 132 and 134 hingedly interconnect sections 122-128 together, such fold lines 130-134 extending longitudinally of liner 116 when the label 110 is adhered thereto. In this particular embodiment, second flat section 124 is folded inwardly on top of first section 122, and then fourth section 128 is folded outwardly or in a reverse direction about fold line 134 to overlie second section 124. When label 110 is fully folded, third section 126 is folded inwardly about fold line 130 into overlying relationship with fourth section 128. Thus, when label 110 is fully folded, sections 122-128 are disposed in mutually superimposed relationship with one another.

Sections 122, 124 and 126 are all of essentially the same width in a transverse direction with respect to the fold lines 130, 132 and 134. However, fourth section 128 is somewhat narrower than second section 124 and thus presents an exposed margin 136 of second section 124 when fourth section 128 is folded on top of second section 124 as illustrated in FIG. 7. Although fourth section 128 thus exposes part of second section 124, third section 126 does not, such that the marginal edge of third section 126 overlies exposed margin 136 when label 110 is fully folded as illustrated in FIG. 6.

Advantageously, an area of transparent repositionable adhesive in the nature of a strip 138 is provided on exposed margin 136 to be engaged by the overlying marginal edge of third section 126 when label 110 is fully folded. Thus, adhesive strip 138 functions to releasably maintain label 110 in its folded condition, notwithstanding the presence of the fourth flat section 128. Preferably, strip 138 is spaced inwardly slightly from fold line 132 and does not extend completely to the opposite leading and trailing edges of second section 12.

As illustrated in FIG. 8, the area of repositionable adhesive on second section 12 may also include one or more spots 140 of clear adhesive spaced inwardly from strip 138 generally toward fold line 134. These spots 140 are useful in contacting fourth section 128 when fourth section 128 is folded into overlying relationship with second section 124, thus helping to releasably retain the label 110 in a fully folded condition.

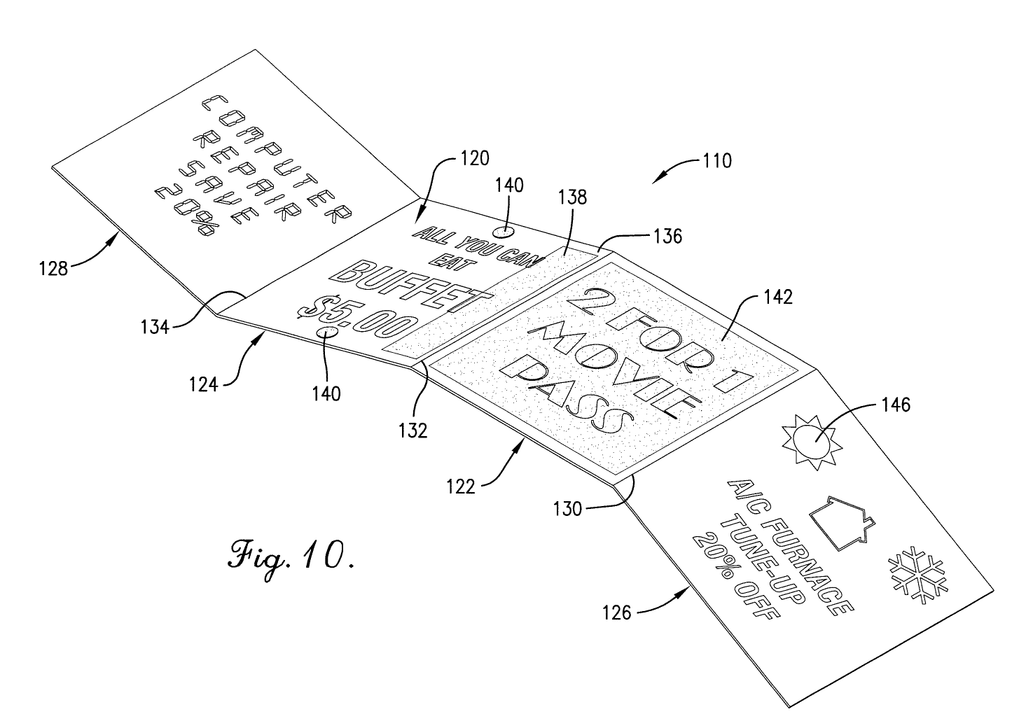

As illustrated particularly in FIG. 10, back side 120 of label 110 is provided with a region 142 of transparent repositionable adhesive for releasably adhering label 110 to liner 116. Alternatively, adhesive 142 may comprise a suitable permanent adhesive, such as a hot melt adhesive. Preferably, region 142 is of rectangular configuration and has its outer extremities spaced inwardly from corresponding edges and fold lines of label 110 in the same manner as region 40 of the first embodiment. Suitable indicia 144 or images may be printed on the front side 118 of label 110; similarly, indicia 146 or images may be printed on the back side 120 of label 110. As illustrated particularly in FIG. 6, when label 110 is fully folded, the back side of third section 126 serves as the top of the folded label.

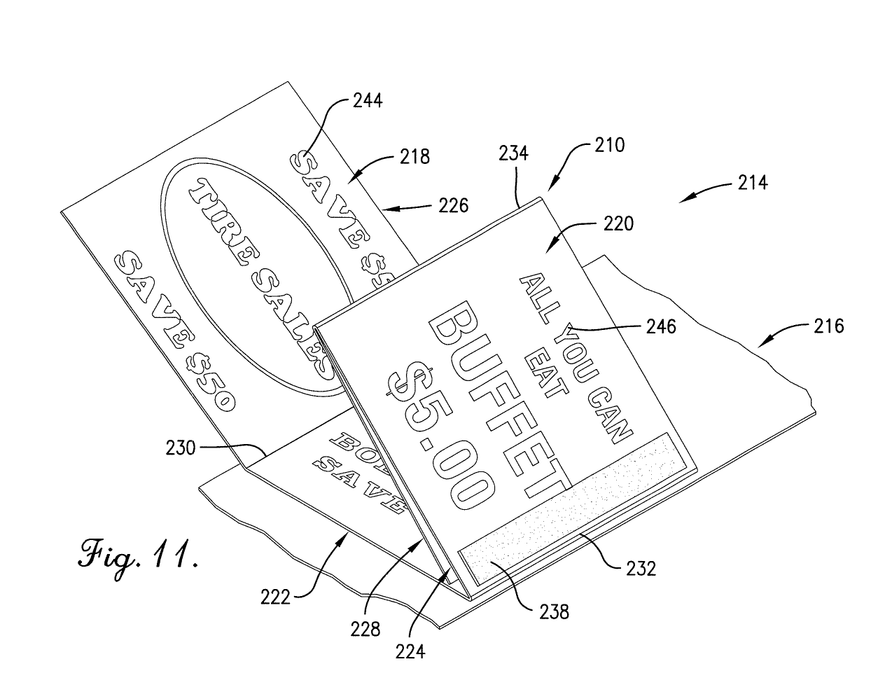

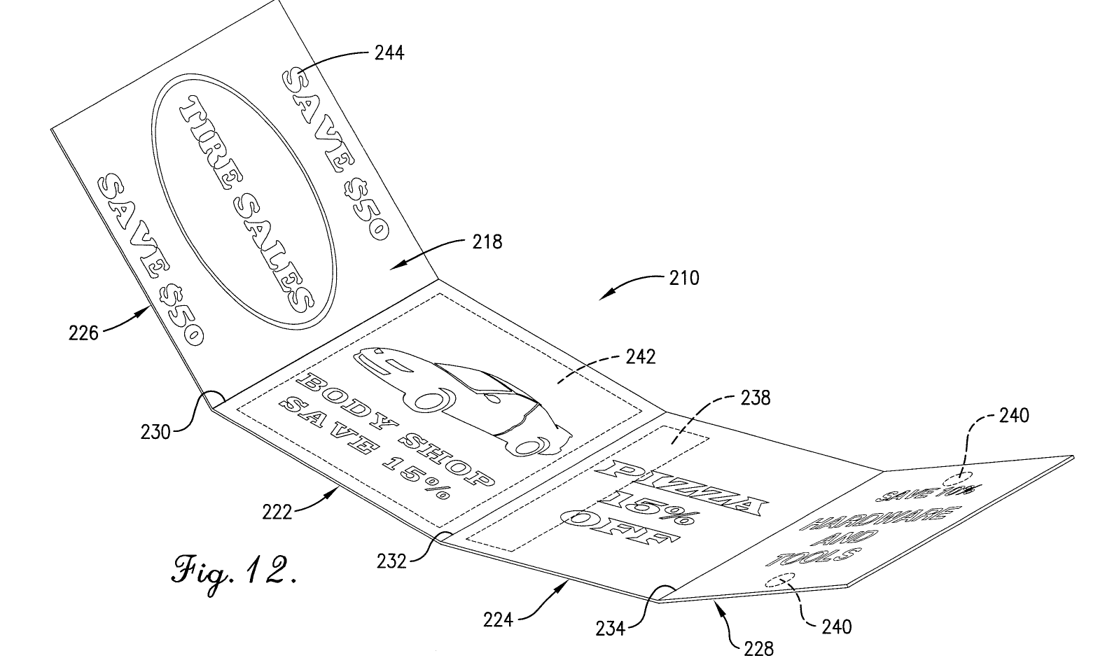

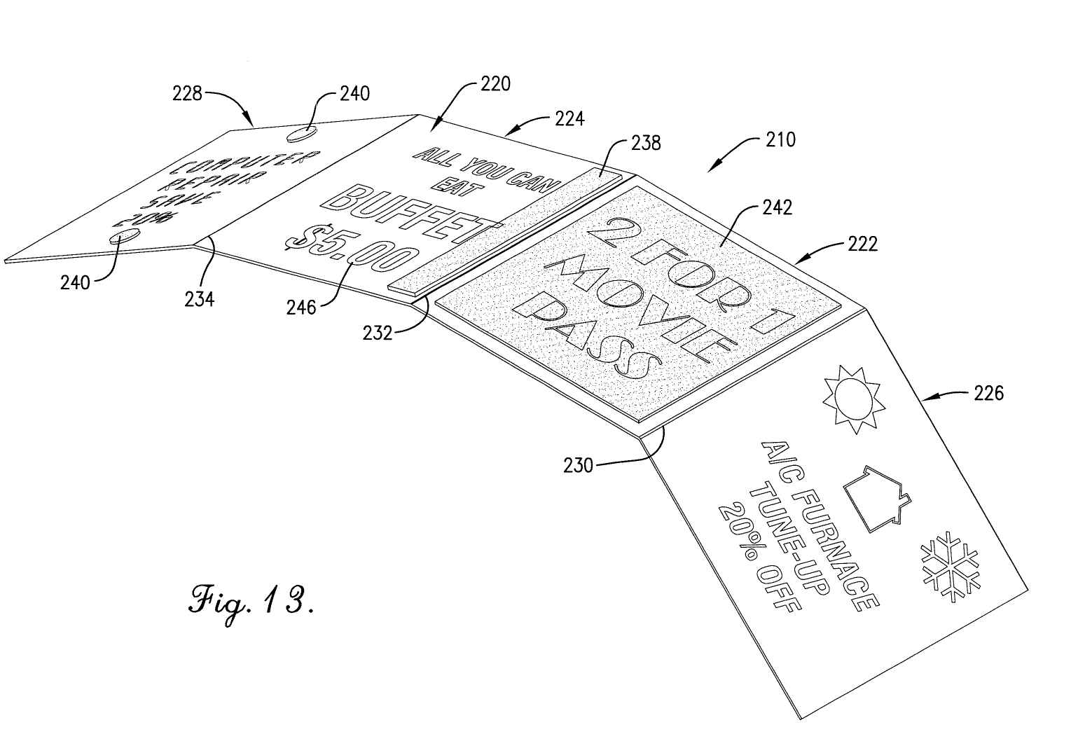

FIGS. 11-13 relate to a third embodiment of a folded web label product 214. Product 214 includes as its two main components a folded label 210 and a liner 216. This eight panel label 210 is similar to label 110 except primarily for the way the fourth section is folded. In this respect, it will be noted that the fourth section 228 is folded downwardly and inwardly about fold line 234 in the same direction as second section 224 is folded about fold line 232 instead of the reverse folding arrangement of label 110. Additional sections (not shown) can be attached to the free edge of fourth section 228 to increase the number of panels beyond 8, in which event such additional sections may be alternately reversely folded in a zig-zag pattern leading from second section 224 and fourth section 228. When label 210 is fully folded, second section 224 overlies fourth section 228 and any additional sections connected thereto while third section 226 overlies second section 224.

Label 210 has a front side 218 and a back side 220. A rectangular region of adhesive 242 (transparent and repositionable) is disposed on the back side 220 of first section 222. Alternatively, adhesive 242 may comprise a suitable permanent adhesive, such as a hot melt adhesive. Adhesive region 242 releasably secures label 210 to liner 216. In addition, an area of transparent, repositionable adhesive in the nature of a strip 238 is disposed alongside of but spaced inwardly from fold line 232 for the purpose of making contacting engagement with the outer marginal edge of section 226 when label 210 is fully folded. This assists in keeping label 210 folded until intentionally opened by the ultimate user. Assisting in releasably retaining label 210 in a folded condition are additional areas of transparent repositionable adhesive on back side 220 including, for example, a pair of spots 240 on the back side of fourth section 228. Spots 240 are thus disposed to come into releasable, contacting engagement with the top side of first section 222 when label 210 is in a fully folded condition. As with the other embodiments, fold lines 230, 232 and 234 all extend longitudinally of liner 216 when the label 210 is attached thereto, and suitable indicia and images 244 and 246 may be located on the front and back of label 210 respectively. The backside of third section 226 becomes the top or front of label 210 when label 210 is carried on liner 216.

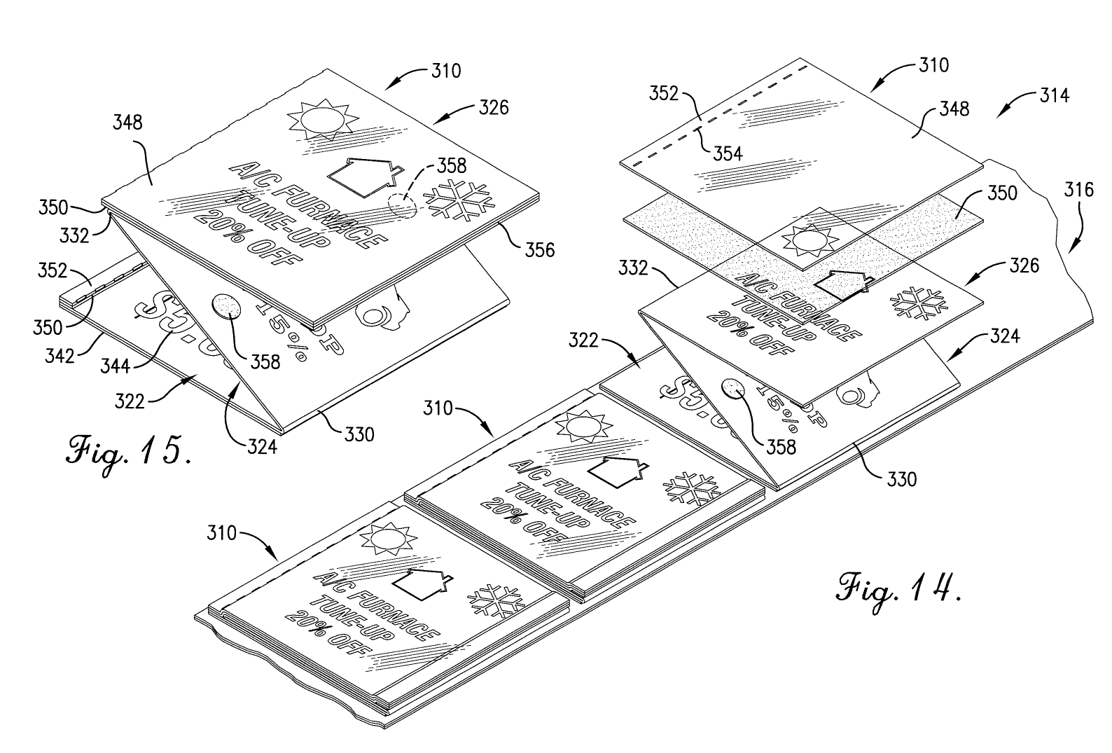

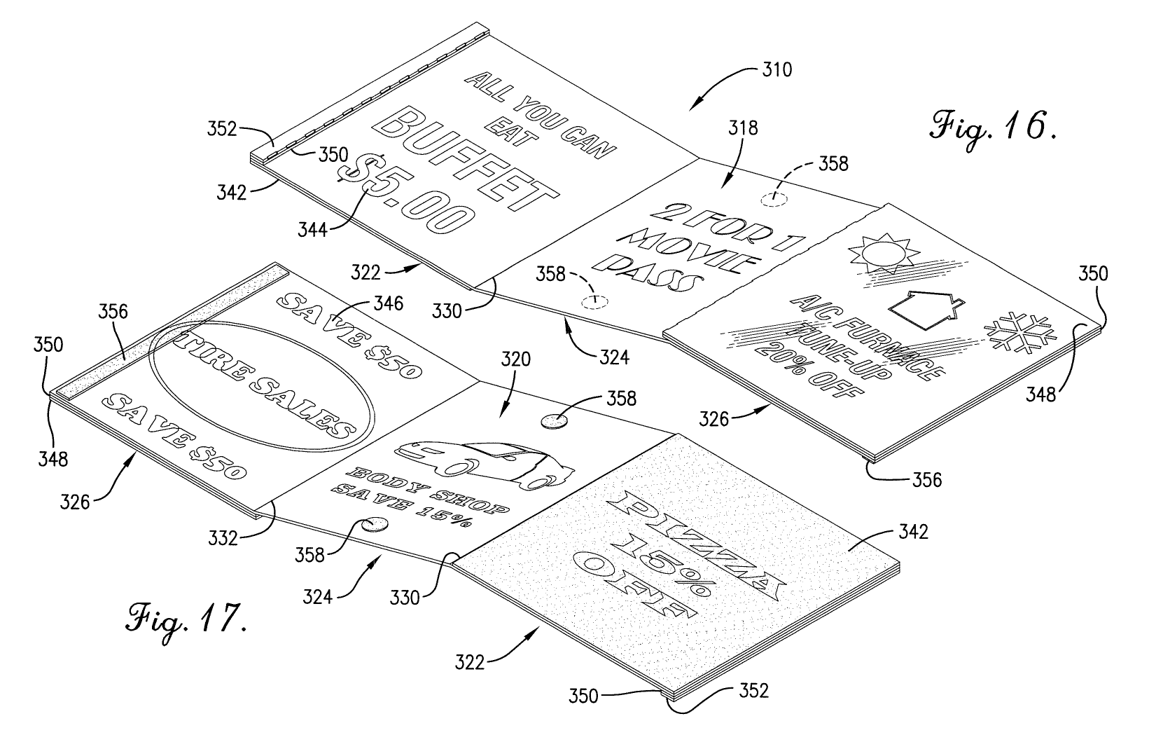

FIGS. 14-17 relate to a fourth embodiment of folded web label product in accordance with the present invention, such fourth embodiment being identified by the numeral 314. The two primary components of product 314 comprise folded labels 310 and the liner 316 to which they are releasably secured.

In the illustrated embodiment, each of the folded labels 310 has three sections 322, 324 and 326 folded in a general zig-zag pattern to present a pair of laterally spaced fold lines 330 and 332 that extend longitudinally of liner 316 when the label is attached thereto. When label 310 is fully folded, second section 324 overlies first section 322, and third section 326 overlies second section 324 such that the three sections of the label are disposed in mutually superimposed relationship with one another.

Label 310 has a front side 318 and a back side 320. Indicia 344 and images may be provided on front side 318, while indicia and images 346 may be provided on back side 320. A region of transparent, repositionable adhesive 342 on the back side of first section 322 releasably adheres folded label 310 to liner 316, such region of adhesive 342 contacting the release coating of liner 316 in the same manner as in previous embodiments. Alternatively, adhesive 342 may comprise a suitable permanent adhesive, such as a hot melt adhesive. Although region 342 is illustrated in FIG. 17 as completely covering the back side of first section 322, it is to be understood that such region could be of slightly reduced dimensions so as to provide clear marginal portions that are adhesive-free as in the prior embodiments.

In contrast to previous embodiments, label 310 is releasably maintained in a fully folded condition in part by the use of a transparent, preferably plastic overlaminate layer 348 that completely covers third section 326 and a marginal portion of first section 322. In this respect, sections 324 and 326 are slightly narrower than first section 322 such that, when label 310 is fully folded, fold line 332 between second and third sections 324, 326 does not extend entirely to the free edge of first section 322, as perhaps shown best in FIG. 14 viewing the labels 310 that are fully folded in that figure. Thus, an overlaminate layer 348 having essentially the same dimensions as first section 322, and supplied with a layer of transparent, permanent adhesive 350 on the underside thereof, can be laid on top of the marginal portion of first section 322 and the entire surface of third section 326 when third section 326 and second section 324 are fully folded up against first section 322. This causes the presentation of an overlaminate margin 352 that becomes adhered to a corresponding margin of first section 322 such that overlaminate 348 becomes adhered to both the top side of third section 326 and the marginal top side of first section 322. A line of weakness 354, such as scoring or perforations, is provided in overlaminate layer 348 in a location slightly outboard of the fold line 332 so as to permit the main portion of overlaminate 348, third section 326, and second section 324 to be gripped as a collective group and torn free along the overlaminate's line of weakness 354. This allows label 310 to be unfolded. It is anticipated that such opening or unfolding of label 310 will take place only after the ultimate customer has peeled label 310 off the newspaper section or other article to which it is attached. Once removed from the newspaper section or other article, the label 310 may be adhered to an environmental surface by pressing the back side of first section 322 against the surface to engage repositionable adhesive 342 with the surface.

In addition to overlaminate 348, an area of transparent, repositionable adhesive in the nature of a strip 356 may be provided on the back side of third section 326 along the free edge thereof. Thus, strip 356 is in position to make contacting engagement with second section 324 when label 310 is fully folded, thereby releasably holding third section 326 against second section 324. In a preferred embodiment, strip 356 of repositionable adhesive is spaced slightly inboard of the free edge of third section 326, as well as the leading and trailing edges thereof so as to provide adhesive-free margins in those locations. Additionally, spots 358 of transparent, repositionable adhesive may be provided on the back side of second section 324 for engaging the back side of third section 326 when label 310 is fully folded so as to further assist in releasably holding label 310 in a fully folded condition.

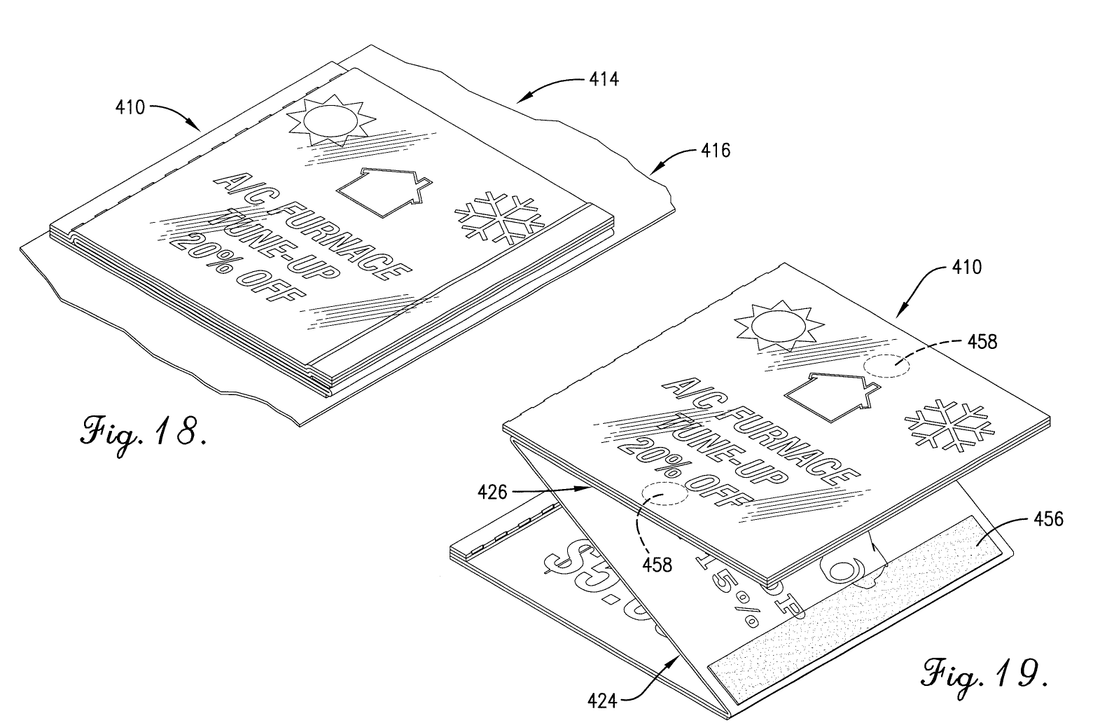

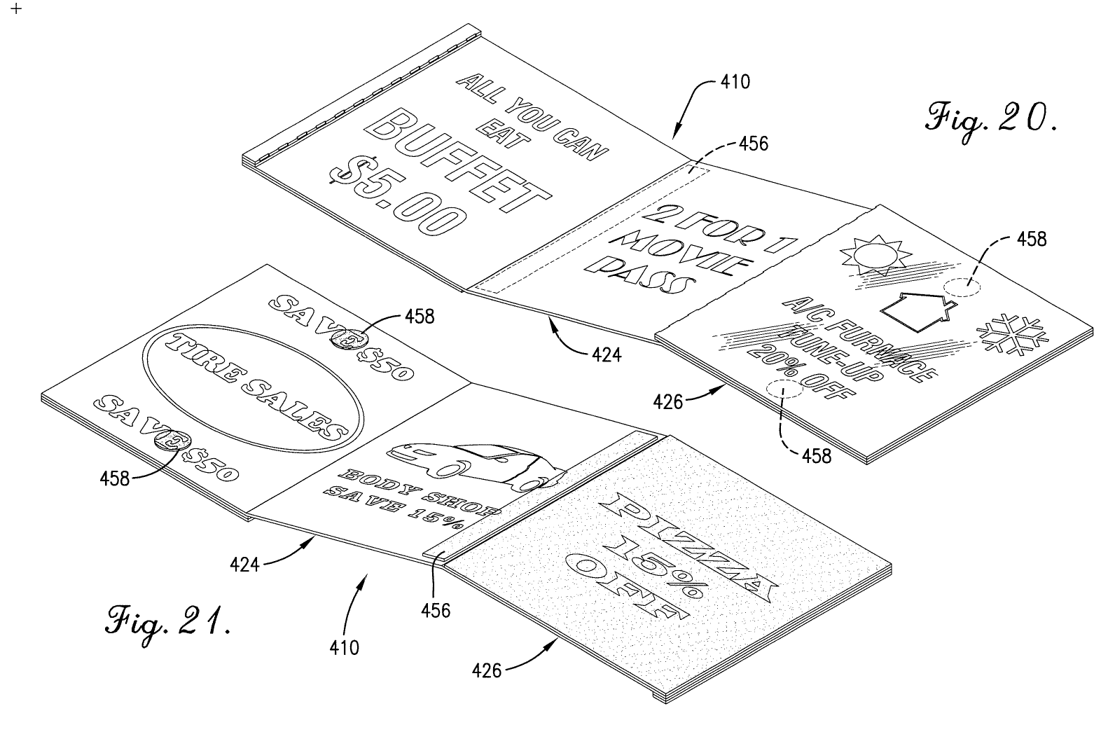

FIGS. 18-21 relate to a fifth embodiment of folded web label product in accordance with the present invention, such product being identified by the numeral 414. The primary components of product 414 are a series of folded labels 410 and a liner 416 to which they are releasably adhered.

Each of the folded labels 410 is identical to folded label 310, with the exception of the location of transparent, repositionable adhesive. In this respect, while adhesive strip 356 is located on the back side of third section 326 for label 310, in label 410 corresponding adhesive strip 456 is located on the back side of second section 424. Thus, adhesive strip 456 is in position to make contacting engagement with the back side of third section 426 when label 410 is fully folded. In addition, while in label 310 the adhesive spots 356 are disposed on the back side of second section 324, in label 410 such corresponding adhesive spots 458 are located on the back side of third section 426. Such spots 458 are thus in position to make contacting engagement with the back side of second section 424 when label 410 is fully folded.

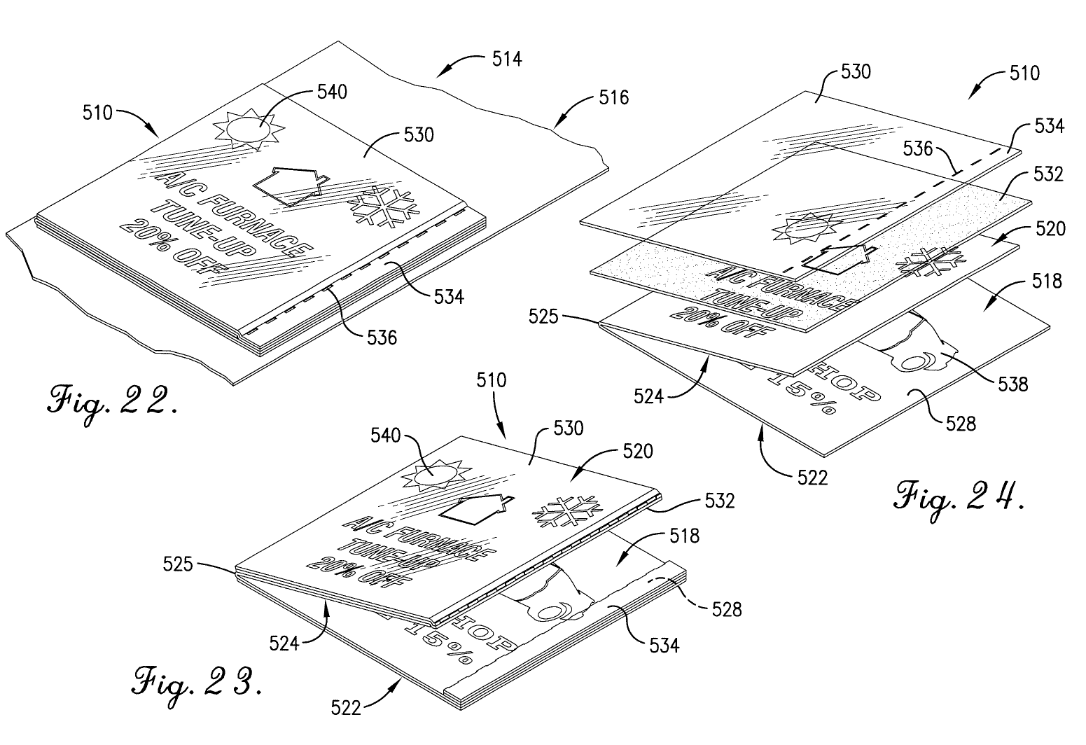

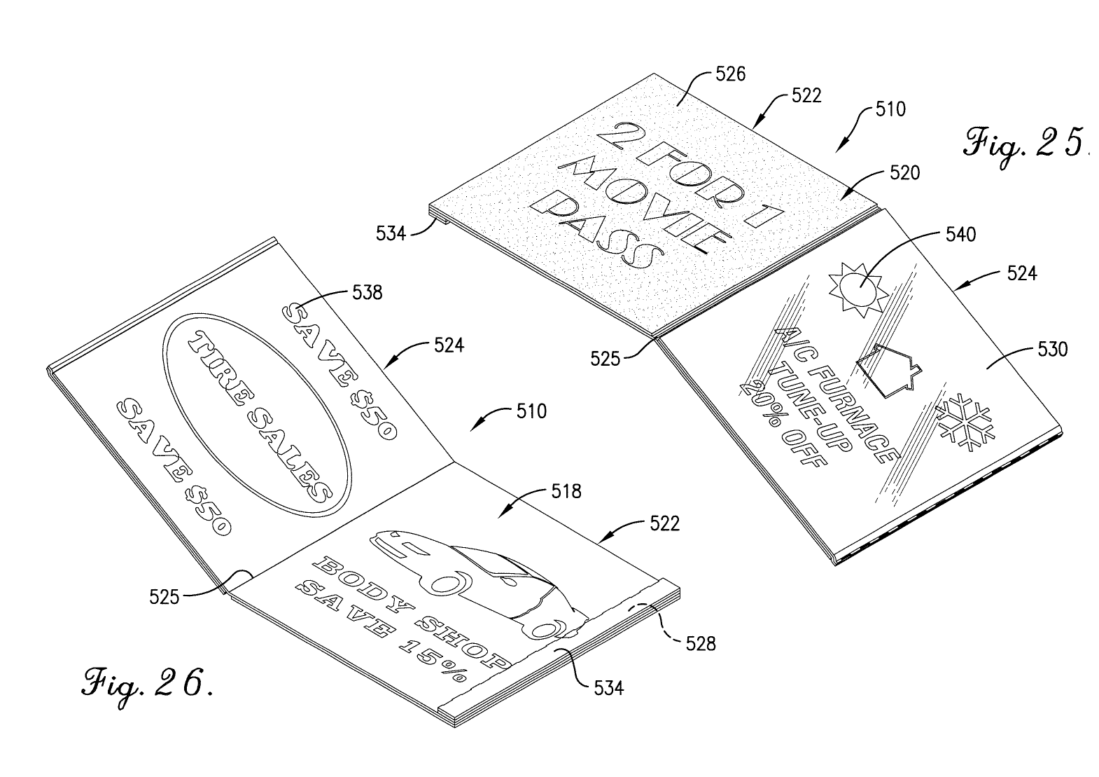

FIGS. 22-26 relate to a sixth embodiment of folded web label product in accordance with the present invention, such product being denoted by the numeral 514. Product 514 comprises two primary components, namely a series of folded labels 510 and a liner 516 to which the labels 510 are releasably adhered.

Each folded label 510 is a four panel label having a front side 518 and a back side 520. Label 510 is folded once in the middle to present a pair of flat sections 522 and 524 that are hingedly interconnected to one another along a fold line 525. Second section 524 overlies first section 522 when label 510 is fully folded, such that sections 522 and 524 are disposed in mutually superimposed relationship to one another.

The back side 520 of first section 522 is provided with a region of transparent repositionable adhesive 526 for releasably adhering label 510 to the release coating on the top side of liner 516. Alternatively, adhesive 526 may comprise a suitable permanent adhesive, such as a hot melt adhesive. Although adhesive region 526 is illustrated as covering the entirety of the back side of first section 522, in one preferred form region 526 will have four marginal areas that are adhesive-free as in at least most of the prior embodiments.

Second section 524 is somewhat narrower than first section 522. Thus, when second section 524 overlies first section 522, second section 524 leaves an exposed lateral margin along the unfolded lateral edge of first section 522, such exposed margin being generally identified by the numeral 528 in FIG. 24. Such margin 528 can be advantageously used to help in providing a way of maintaining label 510 in its folded condition both on and off liner 516. In this respect, a transparent plastic overlaminate layer 530 having dimensions corresponding to that of second section 524 may be supplied with a layer 532 of transparent permanent adhesive for securing overlaminate layer 530 in place. Adhesive layer 532 extends over the entire bottom surface of overlaminate layer 530 such that, when second section 524 is disposed flatly against the first section 522 in a fully folded or closed condition such as illustrated in FIG. 22, a corresponding lateral margin 534 of overlaminate layer 530 and adhesive layer 532 overhangs the free edge of second section 524 and engages exposed margin 528 of first section 522. Thus, overlaminate 530 becomes adhered not only to second section 524, but also to the exposed margin 528 of first section 522, thereby maintaining label 510 closed.

In one embodiment, overlaminate 530 may be provided with a line of weakness 536 in the nature of perforations or scoring in the area of lateral margin 534just outboard of the free outer edge of second section 524 to enable overlaminate 530 and second section 524 to be gripped and pulled upwardly to tear overlaminate 530 along line 536 for the purpose of releasing label 510 for unfolding. FIGS. 23, 25 and 26 illustrate the overlaminate layer 530 torn along line 536, releasing second section 524 and leaving a remnant of overlaminate layer 530 on the otherwise exposed margin 528 of first section 522.

As in the earlier embodiments, the front side 518 of label 510 may be provided with indicia or images 538, while back side 520 may similarly be provided with indicia and images 540. When the label 510 is fully folded in a closed condition as illustrated in FIG. 22, for example, the back side 520 of second section 524 becomes the top surface of the folded label.

It should be apparent from the foregoing that extended note or folded note labels in accordance with the present invention are produced without any carrier label of any kind. They are adhered directly to the liner at the time of production and directly to the publication or other article at the time of application. Thus, they can be produced at a substantial cost savings over conventional extended note labels, and the labels with repositionable adhesive leave no plastic residue when detached from a newspaper section or other article.

Notwithstanding the absence of a carrier label, folded labels in accordance with the present invention can remain fully closed and folded at all times after production, until intentionally unfolded by the ultimate customer or other user. Once folded on the liner, they remain securely closed by their repositionable adhesive, overlaminate layer, or both as the case may be, so as to withstand the rigors of packaging and shipment to applicating companies, the high speed application of the labels by such companies to newspaper sections or other articles, and the delivery of labeled newspaper sections or other articles to the ultimate customer or user. Upon reaching the ultimate customer or user, the labels with repositionable adhesive may be easily peeled from the newspaper section or other article and saved in a secure place or attached and reattached as often as desired to a convenient environmental surface.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. A web label product comprising:
an elongated liner having a release coating on at least one side thereof; and
a plurality of folded labels removably attached to said one side of the liner at spaced locations along the length thereof,
each of said folded labels having a front side and a back side and comprising at least a pair of flat, mutually superimposed sections hingedly interconnected by a fold line that extends longitudinally of the liner,
the back side of at least one of said sections having a region of pressure-sensitive adhesive in contact with the release coating on said one side of the liner to permit the folded label to be removed from the liner and applied to an article while still folded.

2. A web label product as claimed in claim 1,
said adhesive in said region comprising a repositionable adhesive.

3. A web label product as claimed in claim 1,
a second of said sections being narrower than said one section to present an exposed lateral margin on said one section when the second section overlies the one section,
said folded label further comprising a layer of transparent laminate material adhered to and overlying the second section and said exposed lateral margin of the one section for retaining the label in a folded condition.

4. A web label product as claimed in claim 3,
said layer of laminate material having a longitudinally extending line of weakness above the exposed lateral margin of the one section to permit the layer of laminate material to be separated along the line of weakness and release the label for unfolding.

5. A web label product as claimed in claim 4,
said line of weakness comprising a line of perforations.

6. A web label product as claimed in claim 3,
further comprising at least a third flat section hingedly joined to the second section along a fold line and folded reversely from the second section,
said third section being narrower than the first section and said layer of laminate material overlying the third section.

7. A web label product as claimed in claim 6,
further comprising an area of repositionable adhesive between the second and third sections for assisting in holding the third section against the second section.

8. A web label product as claimed in claim 7,
said area of repositionable adhesive comprising at least one spot of repositionable adhesive on the back side of the second section.

9. A web label product as claimed in claim 7,
said area of repositionable adhesive comprising a strip of repositionable adhesive on the back side of the second section adjacent the fold line between the first and second sections.

10. A web label product as claimed in claim 9,
said area of repositionable adhesive further comprising at least one spot of repositionable adhesive on the back side of the third section.

11. A web label product as claimed in claim 1,
said folded label comprising at least three mutually superimposed, flat sections hingedly interconnected by a pair of laterally spaced fold lines that extend longitudinally of the liner.

12. A web label product as claimed in claim 11,
further comprising an area of pressure-sensitive repositionable adhesive on the back side of a second of said sections for releasably retaining the label in a folded condition.

13. A web label product as claimed in claim 12,
said second section and a third section being disposed on opposite sides of said one section,
said label being folded in such a manner that said second section is folded inwardly and overlies said one section and the third section is folded inwardly and overlies said second section,
said area of pressure-sensitive repositionable adhesive being disposed in contact with the front side of said third section.

14. A web label product as claimed in claim 13,
said area of pressure-sensitive repositionable adhesive comprising a strip of adhesive adjacent a fold line that joins the second section with said one section.

15. A web label product as claimed in claim 14,
said area of pressure-sensitive repositionable adhesive further comprising at least one spot of adhesive spaced from said strip generally toward a free edge of the second section.

16. A web label product as claimed in claim 15,
all of the adhesive on the label comprising transparent adhesive.

17. A web label product as claimed in claim 13,
further comprising one or more additional flat sections hinged to the second section along a fold line,
said third section being folded inwardly into overlying relationship with said one or more additional sections.

18. A web label product as claimed in claim 17,
each of said one or more additional flat sections being narrower than the second section and being disposed on top of the second section in such a way that a lateral margin of the second section is exposed by said one or more additional sections,
said area of repositionable adhesive being disposed on said lateral margin of the second section,
said third section being folded into contacting engagement with the area of repositionable adhesive on the exposed lateral margin of the second section.

19. A web label product as claimed in claim 18,
said one or more additional flat sections being alternately reversely folded in a series leading away from the second section.

20. A web label product as claimed in claim 19,
said area of pressure-sensitive repositionable adhesive comprising a strip of adhesive adjacent a fold line that joins the second section with said one section.

21. A web label product as claimed in claim 17,
said one or more additional flat sections being folded under said second section.

22. A web label product as claimed in claim 21,
said one or more additional flat sections being alternately reversely folded in a series leading away from said second section.

23. A web label product as claimed in claim 21,
said area of pressure-sensitive repositionable adhesive comprising a strip of adhesive adjacent a fold line that joins the second section with said one section.
